(19) United States
(12) Patent Application Publication
(10) Pub. No.: US 2021/0170682 A1
(43) Pub. Date: Jun. 10, 2021

(54) METHODS AND SYSTEMS FOR INCREASING LAYER-TO-LAYER BOND STRENGTH

(71) Applicant: The Boeing Company, Chicago, IL (US)

(72) Inventors: William Ryan Cooper, Maple Valley, WA (US); Kirk Douglas Skaggs, Kent, WA (US); Leon C. Cheung, Kent, WA (US); Darron Harris, Auburn, WA (US)

(21) Appl. No.: 16/708,943

(22) Filed: Dec. 10, 2019

(51) Int. Cl. B29C 64/209; B29C 64/118; B29C 64/295; B29C 64/393

(52) U.S. Cl. CPC B29C 64/209; B29C 64/118; B33Y 10/00; B29C 64/393; B29C 64/295

(57) ABSTRACT

Methods of forming a part via additive manufacturing include depositing a first layer of thermoplastic material along a first path via an extruder head, initiating deposition of a second layer of thermoplastic material along a second path via the extruder head, and monitoring a thermal profile of the first layer along the first path while the second layer is deposited. Methods also include determining an energy that is sufficient to raise a present temperature of a cooled portion of the first layer to within a higher temperature range that is greater than or equal to a predetermined threshold temperature, and heating the cooled portion of the first layer to within the higher temperature range before the second layer of thermoplastic material is added to the cooled portion. Systems include an extruder head configured to deposit a plurality of layers of thermoplastic material, a thermal imaging system, and a heating system.

### FIELD

The present disclosure relates generally to methods and systems for increasing bond strength between adjacent layers of materials in additive manufacturing processes.

### BACKGROUND

In additive manufacturing processes (e.g., fused filament fabrication), a physical object is created using layer-by-layer deposition, generally with the geometry of each layer being determined by a computer-aided design (CAD) model. Such processes are commonly referred to as 3D printing processes. In many such processes, a feedstock thermoplastic filament material is heated (e.g., melted), extruded through a nozzle (also referred to as an extruder head), and deposited in the pre-determined path layer-by-layer such that each successive layer is deposited on the previous layer. The nozzle is moved under computer control to define each layer, and thereby determining the ultimate printed shape of the object. For example, two dimensional line traces are sequentially deposited on top of one another to build the height of the object being fabricated. Usually, the nozzle primarily is moved in two dimensions to deposit a given layer, and then the object or the nozzle is moved vertically by a small amount to begin the next layer.

The temperature of the preceding layer, or trace, must be within a certain margin to allow newly deposited material to optimally thermally bond with the previous layer. However, a given layer starts to cool immediately after extrusion, with the amount of cooling depending on the length of the trace and how long it takes to complete it. Pauses or interruptions in printing can also cause previous layers to cool too much for optimal thermal bonding. When this happens, bond strength between adjacent layers may be reduced in the completed object, which in turn can affect the overall structural integrity of the resulting part and/or result in delamination. In such cases, the printed object often is discarded and printed again, which creates waste and increased costs.

When 3D printing techniques are used to create large parts, it is cost-prohibitive and/or impractical to heat the entire printing environment/work area to counteract cooling. Additionally, heated environments may also cause warping in large parts. Thus, the size of objects that can be reliably 3D printed is limited by the narrow acceptable range of temperatures for layer-to-layer bonding.

### SUMMARY

In one example, a method of performing an additive manufacturing process in a work area is described. The method includes depositing a first layer of thermoplastic material along a first path via an extruder head, followed by initiating deposition of a second layer of thermoplastic material along a second path via the extruder head. The second layer of thermoplastic material is added to at least a portion of the first layer of thermoplastic material such that the two layers are bonded together (though subsequent layers are generally slightly different in size and/or shape from each other). Methods also include monitoring a thermal profile of the first layer of thermoplastic material along the first path while the second layer of thermoplastic material is deposited, and detecting a cooled portion of the first layer of thermoplastic material having a present temperature that is lower than a predetermined threshold temperature. In response to detecting the cooled portion, methods include determining an energy that is sufficient to raise the present temperature of the cooled portion to within a higher temperature range that is greater than or equal to the predetermined threshold temperature and expending the energy, thereby heating the cooled portion of the first layer of thermoplastic material to the higher temperature range before the second layer of thermoplastic material is added to the cooled portion. After the cooled portion is heated within the higher temperature range, methods include continuing to deposit the second layer of thermoplastic material along the second path.

In another example, a method for repairing a damaged area of a part comprising a thermoplastic material is described. The method includes machining down the damaged area until stable material is reached, thereby removing the damaged area and forming a repair area, determining an energy that is sufficient to raise a present temperature of the stable material to within a higher temperature range that is greater than or equal to a predetermined threshold temperature, and expending the energy, thereby heating the stable material to within the higher temperature range. The expending the energy is performed before a subsequent layer of thermoplastic material is added to the stable material via an extruder head, with the subsequent layer of thermoplastic material being added to the stable material along a path within the repair area. The expending the energy is performed by a heating system that travels above the path as the subsequent layer of thermoplastic material is deposited. The method also includes monitoring a thermal profile of the stable material along the path while the subsequent layer of thermoplastic material is deposited. The monitoring is performed by a thermal imaging system that travels above the path as the subsequent layer of thermoplastic material is deposited.

In another example, a large area additive manufacturing system is described. The large area additive manufacturing system includes an extruder head configured to deposit a plurality of layers of thermoplastic material, a thermal imaging system, and a heating system. The thermal imaging system is configured to monitor a thermal profile of a first layer of thermoplastic material while a second layer of thermoplastic material is deposited on the first layer of thermoplastic material via the extruder head. The thermal imaging system follows and travels above a first path of the first layer of thermoplastic material while the second layer of thermoplastic material is deposited. The thermal imaging system is generally configured to compare the thermal profile to a predetermined threshold temperature and to detect any cooled portions of the first layer of thermoplastic material having a present temperature that is lower than the predetermined threshold temperature, based on the thermal profile. The heating system is configured to follow and travel above the first path as the second layer of thermoplastic material is deposited, with the heating system being configured to heat the cooled portion(s) to within a higher temperature range that is greater than or equal to the predetermined threshold temperature before the second layer of thermoplastic material is added to a given cooled portion of the first layer. The thermal imaging system also is configured to determine an energy sufficient to raise the present temperature of each cooled portion to within the higher temperature range, and the heating system is configured to expend the determined amount of energy such that the energy expended by the heating system is minimized.

### BRIEF DESCRIPTION OF THE DRAWINGS

FIG. 1 is a schematic diagram representing disclosed large area additive manufacturing systems.

FIG. 2 is a schematic diagram representing additional disclosed large area additive manufacturing systems.

FIG. 3 is a perspective view of an example of a part that is in the process of being manufactured according to presently disclosed methods.

FIG. 4 is a flowchart schematically representing methods for forming a part in a work area via an additive manufacturing process.

### DESCRIPTION

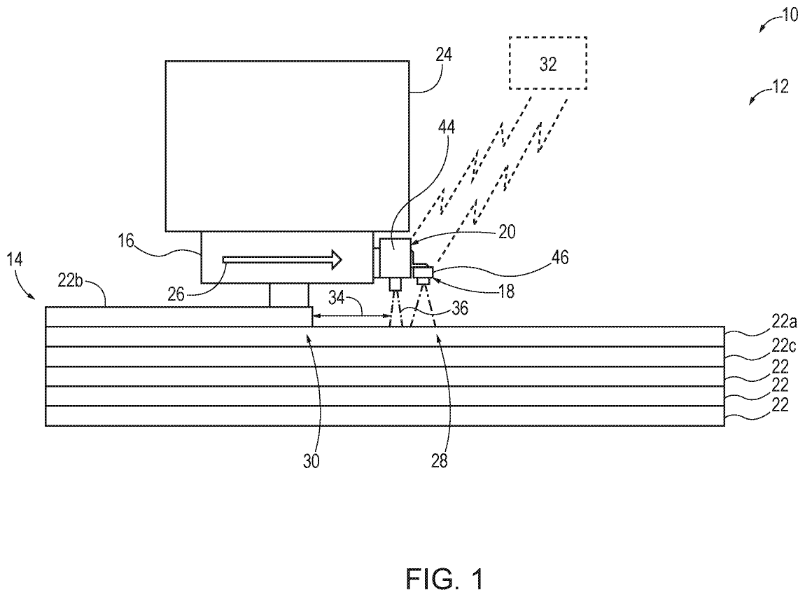

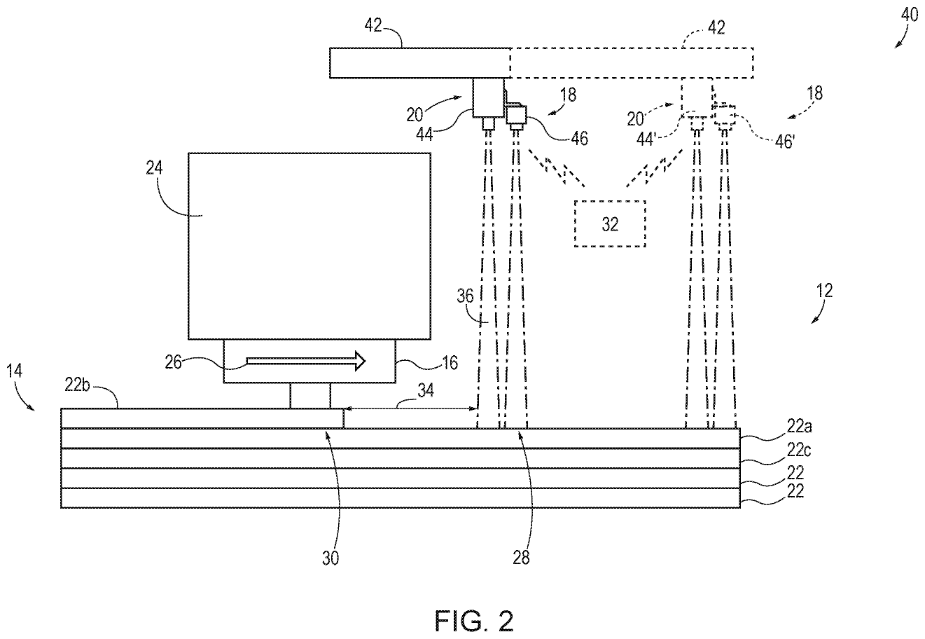

FIGS. 1-2 provide illustrative, non-exclusive examples of large area additive manufacturing systems 10 according to the present disclosure. Elements that serve a similar, or at least substantially similar, purpose are labeled with like numbers in each of FIGS. 1-2, and these elements may not be discussed in detail herein with reference to each of FIGS. 1-2. Similarly, all elements may not be labeled in each of FIGS. 1-2, but reference numerals associated therewith may be utilized herein for consistency. Elements, components, and/or features that are discussed herein with reference to one or more of FIGS. 1-2 may be included in and/or utilized with any of FIGS. 1-2 without departing from the scope of the present disclosure. In general, elements that are likely to be included in a given (i.e., a particular) embodiment are illustrated in solid lines, while elements that are optional to a given embodiment are illustrated in dashed lines. However, elements that are shown in solid lines are not essential to all embodiments, and an element shown in solid lines may be omitted from a particular embodiment without departing from the scope of the present disclosure.

With reference to FIG. 1, large area additive manufacturing systems 10 are illustrated in a work area 12, within which a part 14 is additively manufactured. Systems 10 include an extruder head 16, a thermal imaging system 18, and a heating system 20. As will be described in more detail, extruder head 16 is configured to deposit a plurality of layers 22 (e.g., layer 22a, layer 22b, layer 22c) of thermoplastic material to form part 14. Extruder head 16 is moved as each layer 22 of material is deposited along a respective path, with the material generally being extruded through extruder head 16 by heating (e.g., melting) a feedstock supply 24 of material, such as a feedstock filament spool. For example, each layer 22 of thermoplastic material be comprise a respective 3D printed layer of material.

Thermal imaging system 18 is configured to monitor a thermal profile of a first layer of thermoplastic material (e.g., layer 22a) while a second layer of thermoplastic material (e.g., layer 22b) is deposited on the first layer via extruder head 16. In this manner, thermal imaging system 18 is configured to detect any areas of the previously deposited layer 22 (e.g., layer 22a) before the next layer 22 (e.g., layer 22b) is deposited thereon, such that heating system 20 can heat the areas of the previously deposited layer that are too cool for optimal layer-to-layer bonding. Presently disclosed systems 10 thereby may be configured to increase the strength of layer-to-layer bonding between adjacent layers 22 of part 14 and prevent or reduce delamination in the finished part 14.

Extruder head 16 travels along each respective path of each respective layer 22 as it is being deposited. For example, extruder head 16 travels along a first path to deposit first layer 22a, and along a second path to deposit second layer 22b. One or more respective paths of one or more respective layers 22 may be identical or substantially identical, in some examples. In typical examples, each respective path for each respective layer 22 of thermoplastic material is slightly different from adjacent respective paths of adjacent respective layers 22. Arrow 26 schematically illustrates the direction of travel of extruder head 16 as it deposits layer 22b on layer 22a, along the respective path of layer 22b.

Heating system 20 and thermal imaging system 18 generally are positioned and oriented such that they are aimed slightly ahead of extruder head 16 along the path of the respective layer 22 extruder head 16 is currently depositing. For example, as shown in FIG. 1, thermal imaging system 18 and heating system 20 are aimed at a first area 28 of layer 22a that is ahead of a second area 30 of layer 22a where extruder head 16 is currently positioned and depositing layer 22b thereon. In this manner, thermal imaging system 18 is configured to monitor the thermal profile of a portion of the previously deposited layer (e.g., layer 22a) just before extruder head 16 deposits the subsequent layer (e.g., layer 22b) on that portion. Similarly, heating system 20 is configured to heat the portion of the previously deposited layer (e.g., layer 22a) just before extruder head 16 deposits the subsequent layer (e.g., layer 22b) on that portion. Thus, systems 10 may be configured to improve layer-to-layer bonding between adjacent layers (e.g., between layer 22a and layer 22b) by ensuring that the previously deposited layer has a surface temperature (and/or a temperature at a certain depth in the thickness of the layer 22) that is above the predetermined threshold temperature before the next layer is deposited thereon.

In system 10, thermal imaging system 18 travels above each respective path as each layer 22 is deposited. For example, thermal imaging system 18 traveled above the path of layer 22c as layer 22a was deposited, and is shown in the process of traveling above a path of layer 22a as layer 22b is being deposited. Thermal imaging system 18 generally is moved along each respective path of deposition. In other words, as each respective layer 22 is deposited, thermal imaging system 18 travels to follow the respective path of the previously deposited layer 22, except that thermal imaging system 18 is vertically displaced from (i.e., positioned above) the previously deposited layers 22 of part 14. In other words, as used herein, thermal imaging system 18 may be said to travel along, or move along, a given path of a respective layer 22 even though it is positioned above said path.

Similarly, heating system 20 travels above each respective path as each layer 22 is deposited. For example, heating system 20 traveled above the path of layer 22c as layer 22a was deposited, and is shown in the process of traveling above a path of layer 22a as layer 22b is being deposited. Heating system 20 generally is moved along each respective path of deposition. In other words, as each respective layer 22 is deposited, heating system 20 moves to follow the respective path of the previously deposited layer 22, except that heating system 20 is vertically displaced from (i.e., positioned above) the previously deposited layers 22 of part 14. In other words, as used herein, heating system 20 may be said to travel along, or move along, a given path of a respective layer 22 even though it is positioned above said path. Described another way, thermal imaging system 18 and heating system 20 are operatively coupled relative to extruder head 16 and are configured to move with extruder head 16 in system 10, with heating system 20 and thermal imaging system 18 being configured to precede extruder head 16 as extruder head 16 moves along the path of deposition (e.g., in the direction indicated by arrow 26 in the example shown in FIG. 1). In some examples, thermal imaging system 18 and heating system 20 are directly coupled to each other. In other examples, each of thermal imaging system 18 and heating system 20 may be operatively coupled to extruder head 16 such that each moves along with extruder head 16 without being coupled to each other. In yet other examples, heating system 20 and thermal imaging system 18 may be configured to move with extruder head 16 along each path of deposition without being coupled to extruder head 16.

Thermal imaging system 18 is configured to monitor the thermal profile of the previously deposited layer (e.g., the thermal profile of layer 22a) while the current layer (e.g., layer 22b) is being deposited. Thermal imaging system 18 (and/or a controller 32 that thermal imaging system 18 is in electronic communication with) is configured to compare the thermal profile to a predetermined threshold temperature and to detect any cooled portions of the previous layer of thermoplastic material having a present temperature that is lower than the predetermined threshold temperature, based on the thermal profile. In turn, heating system 20 is configured to heat each detected cooled portion of the previous layer (e.g., any detected cooled portion or portions of layer 22a) to within a higher temperature range that is greater than or equal to the predetermined threshold temperature, before the next layer (e.g., layer 22b) of thermoplastic material is added to the respective cooled portion. For example, if thermal imaging system 18 detects that first area 28 of layer 22a has cooled to a temperature below the predetermined threshold temperature, heating system 20 then delivers sufficient heat 36 to first area 28 to raise the temperature of first area 28 above the predetermined threshold temperature before extruder head 16 gets to first area 28 and deposits layer 22b thereon. The predetermined threshold temperature for a given layer 22 may vary depending on the particular thermoplastic material being used and the optimal temperature range for layer-to-layer bonding of that material. In specific examples, the predetermined threshold temperature may be between 100 degrees Fahrenheit (° F.) and 550° F., between 150° F. and 500° F., between 150° F. and 200° F., between 200° F. and 250° F., between 250° F. and 300° F., between 300° F. and 350° F., between 350° F. and 400° F., between 400° F. and 450° F., and/or between 450° F. and 500° F. Specific materials used in a given example may have a predetermined threshold temperature that is less than 100° F. or greater than 500° F.

In some examples of system 10, thermal imaging system 18 (optionally in conjunction with heating system 20 and/or controller 32) is configured to determine and/or calculate the energy sufficient to raise the present temperature of any detected cooled portions to within the higher temperature range. For example, the energy may be calculated based on rules or algorithms, or determined from a lookup table or other stored mathematical data. In other words, heating system 20 may be configured to deliver selective amounts of energy depending on how much the detected cooled portions have cooled (e.g., depending on how much the temperature of the cooled portions should be raised for optimal layer-to-layer bonding). Heating system 20 is configured to expend the energy determined and/or calculated by thermal imaging system 18 such that the energy expended by heating system 20 is minimized. As used herein, the expended energy is “minimized” when the energy expended is no more than 20% greater than the smallest energy expenditure by heating system 20 that would result in the desired increase in temperature.

In some examples of system 10, extruder head 16 is a rotating extruder head. Additionally or alternatively, heating system 20 and/or thermal imaging system 18 may be selectively rotated with respect to extruder head 16 in some systems 10. Additionally or alternatively, extruder head 16 may comprise a fixed extruder head for, for example, fused filament fabrication. Additionally or alternatively, extruder head 16 may comprise a polymer pellet extruder head. Extruder head 16 may include a plurality of nozzles for depositing material in some systems 10. While feedstock supply 24 is shown coupled to extruder head 16, in other examples, at least a portion of feedstock supply 24 may be spaced apart from extruder head 16 and operatively coupled thereto such that material may be extruded from feedstock supply 24 without the entire feedstock supply moving along with extruder head 16 as each layer is deposited.

Thermal imaging system 18 generally includes a thermal imaging camera or other thermal sensor 46, with thermal sensor 46 typically being a thermal imaging sensor 46. In some examples, thermal imaging system 18 may include a plurality of thermal imaging sensors 46 (e.g., a plurality of thermal imaging cameras). One or more thermal imaging sensors 46 may be positioned relative to the work area 12 and layers 22 such that they are configured to acquire thermal data (also referred to herein as a thermal profile) associated with part 14 as it is being additively manufactured. Controller 32, which may be a component of thermal imaging system 18 and/or may be a separate controller in electronic communication with thermal imaging system 18, is operatively coupled to the thermal imaging sensor(s) 46 and may be configured to direct delivery of heat 36 from heating system 20 to discrete sections of part 14 based at least in part on the thermal data received from thermal imaging system 18. In other words, the active controlling of the delivery of heat 36 in such examples may be based on real-time thermal data acquired via the one or more thermal imaging sensors 46.

The thermal profile acquired by thermal imaging system 18 may comprise or be surface temperatures of part 14 as it is being additively manufactured. In some such examples, thermal imaging system 18 is configured to acquire the surface temperatures of a discrete section of part 14 as it is being additively manufactured. That is, thermal imaging sensor 46 is purposefully directed at a discrete section of part 14, depending on the current position of thermal imaging system 18 relative to part 14, to acquire the thermal profile of that section, or small area, of part 14. More specifically, by being positioned and configured to acquire a thermal profile of a discrete section of part 14, it is meant that thermal imaging sensor 46 is positioned and configured to acquire thermal data from a defined and specific sub-region, or location, of part 14 being additively manufactured, as opposed to an entirety of part 14 or to a general region or zone of part 14. The discrete section that thermal imaging system 18 is oriented towards moves along the path of the previously deposited layer 22 (e.g., layer 22a), as thermal imaging system 18 moves along said path during deposition of the subsequent layer 22 (e.g., layer 22b). In other words, as thermal imaging system 18 is moved relative to part 14, the discrete section of layer 22 that thermal imaging system 18 is positioned to monitor is changed.

Thermal imaging sensor 46 generally is a contactless thermal camera, in that it does not physically contact part 14 as it is being additively manufactured. Additionally or alternatively, thermal imaging system 18 may include one or more infrared thermometers and/or one or more thermal sensors that physically engage a surface to acquire its temperature, such as, for example, thermocouples, temperature transducers, thermistors, and integrated chip (IC) thermometers.

Heating system 20 generally includes a non-contact heating source 44 (also referred to herein as a heating device 44) configured to raise the surface temperature of at least a portion of at least one layer 22 of deposited material above a predetermined threshold temperature. For example, heating system 20 may include an infrared heater and/or a laser heating system (e.g., an infrared laser) or other directed energy heating system. Additionally or alternatively, heating system 20 may include a hot fluid supply such that heating system 20 may be configured to direct a stream, or jet, of hot fluid (e.g., gas or liquid) to discrete sections of part 14 as it is being additively manufactured. Additionally or alternatively, heating system 20 may include a heat lamp (e.g., an infrared heat lamp or full spectrum heat lamp). Additionally or alternatively, heating system 20 may be configured to deliver a plasma arc, a flame, an electron beam, and/or inductive heating.

Heating system 20 includes at least one heating device 44, but any suitable number of heating devices 44 may be utilized. Heating devices 44 may take any suitable form and configuration, such that they are configured to actively deliver heat 36 to a discrete section of part 14 as it is being additively manufactured. That is, heat 36 is purposefully directed at a discrete section of part 14, depending on the current position of heating system 20 relative to part 14, to impart desired amounts of heat 36 to part 14. More specifically, by being positioned and configured to direct heat 36 to a discrete section of part 14, it is meant that heating device 44 is positioned and configured to direct heat 36 to a defined and specific sub-region, or location, of part 14 being additively manufactured, as opposed to an entirety of part 14 or to a general region or zone of part 14. As heating system 20 is moved relative to part 14, the discrete section of layer 22 that heating system 20 is positioned to direct heat 36 towards is changed.

Put another way, heating system 20 is positioned relative to layers 22 of part 14 such that heating system 20 is configured to locally heat a small area (e.g., first area 28) of a given layer 22 of thermoplastic material at a time, as part 14 is being additively manufactured. For example, heating system 20 may be configured to locally heat a small area less than about 0.5 square inches in area, less than about 1 square inch in area, less than about 2 square inches in area, less than about 3 square inches in area, less than about 4 square inches in area, and/or less than about 5 square inches in area. Additionally or alternatively, heating system 20 may be configured to locally heat a small area that is less than 5% of an overall area of work area 12, less than 1% of the overall area of work area 12, less than 0.5% of the overall area of work area 12, less than 0.1% of the overall area of work area 12, and/or less than 0.05% of the overall area of work area 12. Local heating of just a portion of part 14 being manufactured may help reduce energy expenditure and power consumption by disclosed systems 10, thereby reducing operating costs as compared to conventional techniques.

Work area 12 may be said to have an overall area that is generally larger than the footprint of part 14. In some examples, work area 12 may have an overall area several times larger than the footprint of part 14, such that a plurality of parts 14 may be additively manufactured sequentially within work area 12 without needing to move the completed parts 14 before beginning to manufacture the next part 14. As an illustrative example, the overall area of work area 12 may be at least 5 square feet, at least 10 square feet, at least 15 square feet, at least 20 square feet, at least 25 square feet, at least 30 square feet, at least 35 square feet, at least 40 square feet, at least 45 square feet, at least 50 square feet, at least 75 square feet, and/or at least 100 square feet. Thus, work area 12 may be considered a sufficient size for what is known as large area additive manufacturing, such that work area 12 is sized sufficiently for the additive manufacture of large parts.

In some examples, heating system 20 may be positioned to heat a small area (e.g., first area 28) that is positioned less than 1 inch in front of extruder head 16 along the path of the given layer 22 currently being deposited (e.g., layer 22b in FIG. 1), less than 2 inches in front of extruder head 16 along the path, less than 4 inches in front of extruder head 16 along the path, less than 6 inches in front of extruder head 16 along the path, less than 8 inches in front of extruder head 16 along the path, and/or less than 10 inches in front of extruder head 16 along the path. In FIG. 1, heating system 20 is shown heating a small area positioned a distance 34 in front of extruder head 16 along the path of layer 22b (e.g., ahead of extruder head 16 along the path following the direction indicated by arrow 26). Heating system 20 generally is configured to raise at least the surface temperature of the small area being heated. In some examples, heating system 20 may be configured to heat the entire thickness of the layer being heated, within the small area. In other examples, heating system 20 may be configured to heat the small area through just a portion of the thickness of layer 22.

Controller 32 may be in electronic communication (e.g., wired or wireless communication) with heating system 20 to direct delivery of heat 36 from heating system 20 to different discrete sections of part 14 as heating system 20 moves with respect to part 14 along the path of deposition. Additionally or alternatively, heating system 20 may include an on-board controller configured to do the same. Controller 32 may be any suitable device or devices that are configured to perform the functions of controller 32 discussed herein. For example, controller 32 may include one or more of an electronic controller, a dedicated controller, a special-purpose controller, a personal computer, a special-purpose computer, a display device, a logic device, a memory device, and/or a memory device having computer readable media suitable for storing computer-executable instructions for implementing aspects of systems 10 and/or methods disclosed herein.

Additionally or alternatively, controller 32 may include, or be configured to read, non-transitory computer readable storage, or memory, media suitable for storing computer-executable instructions, or software, for implementing methods or steps of methods according to the present disclosure. Examples of such media include CD-ROMs, disks, hard drives, flash memory, etc. As used herein, storage, or memory, devices and media having computer-executable instructions as well as computer-implemented methods and other methods according to the present disclosure are considered to be within the scope of subject matter deemed patentable in accordance with Section 101 of Title 35 of the United States Code.

As shown in FIG. 1, thermal imaging system 18 and heating system 20 are coupled to extruder head 16 in some examples of systems 10. FIG. 2 schematically illustrates examples of systems 40, which are similar in operation and function to systems 10, except that in systems 40, thermal imaging system 18 and heating system 20 are coupled to a frame structure 42 in addition to or alternatively to being coupled to extruder head 16. In some examples of system 40, thermal imaging system 18 includes a plurality of thermal imaging sensors 46 and/or heating system 20 includes a plurality of heating devices 44 spaced apart from one another and mounted on or coupled to frame structure 42 above work area 12 (and thus above layers 22 as they are deposited to form part 14). For example, FIG. 2 illustrates an example of heating system 20 that includes a first heating device 44 and a second heating device 44′, and an example of thermal imaging system 18 that includes a first thermal imaging sensor 46 and a second thermal imaging sensor 46′. Of course, other examples of systems 40 may include more or fewer thermal imaging sensors 46 and/or more or fewer heating devices 44. Such thermal imaging systems 18 and heating systems 20 may be fixedly mounted to frame structure 42 in some examples. In such examples, each respective heating device 44 may be configured to deliver heat from the heating device to a different respective discrete section of the deposited layer of material (e.g., layer 22a) or different discrete respective area of part 14, when needed. Additionally or alternatively, heating system 20 (e.g., one or more heating devices 44) and/or thermal imaging system 18 (e.g., one or more thermal imaging sensors 46) may be movably coupled to frame structure 42 such that thermal imaging system 18 and/or heating system 20 move with respect to frame structure 42 and follow the respective path of the previous layer 22 of thermoplastic material as the current layer (e.g., layer 22b) is being deposited.

As used herein, “additive manufacturing” refers to the construction of a part from the bonding together of sub-elements thereof from a feedstock (e.g., feedstock supply 24), in which the sub-elements become one to define the whole of the part (e.g., part 14). Additive manufacturing is distinguished from subtractive manufacturing (e.g., machining), in which material is removed from a volume of material to construct a part. Examples of additive manufacturing include (but are not limited to) three-dimensional (3D) printing technologies, such as extrusion deposition, laser sintering, selective laser sintering, direct laser metal sintering, indirect laser metal sintering, powder sintering, laser melting, electron beam melting, lamination, photopolymerization, stereolithography, power fed directed energy deposition, laser metal deposition-wire, and continuous liquid interface production. Various feedstock materials have been used in additive manufacturing, and any suitable feedstock materials may be used in connection with systems 10, including, for example, feedstocks that include one or more of thermoplastics, thermosets, metal powder, metal fibers, fiber reinforced composite materials, including materials that include fiber tows and/or chopped fiber. Systems 10 and systems 40 may be used with any suitable feedstock material and/or may be applied to other types of additive manufacturing other than those specifically described herein. “Additive manufacturing” additionally or alternatively may be described as “additive building,” and similarly, “additively manufactured” additionally or alternatively may be described as “additively built.”

Suitable materials for feedstock supply 24 that may be used to form parts 14 according to additive manufacturing techniques may include acrylonitrile butadiene styrene (ABS), polylactic acid (PLA), high-impact polystyrene (HIPS), thermoplastic polyurethane (TPU), aliphatic polyamides (e.g., nylon), polyethylene terephthalates (PET, PETG), polyetherimide (PEI, e.g., Ultem®), polyethersulfone (PESU), acrylics, polypropylene, polycarbonates, polyvinyl alcohol (PVA), thermoplastic elastomers, polystyrene, and/or lignin, generally in filament form. In some examples, a single material may be used to form each layer of part 14. In other examples, a plurality of materials is used to form part 14, such as by forming different respective layers 22 from a different material or combination of materials, and/or different portions of a given layer 22 from a different material or combination of materials. Materials may be selected and optimized to increase interlaminar bonding between adjacent layers 22.

Systems 10 according to the present disclosure may be retrofit to existing 3D printers or other additive manufacturing systems.

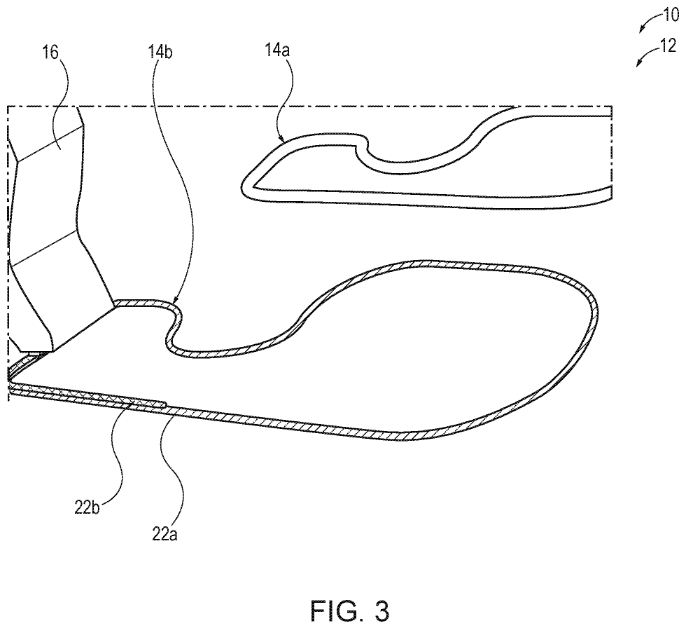

FIG. 3 illustrates an illustrative non-exclusive example of parts being additively manufactured by system 10 according to the present disclosure. FIG. 3 shows two parts in work area 12, with part 14a being completed and cooling, and part 14b currently being manufactured via extruder head 16 (each of part 14a and 14b is an example of part 14). In FIG. 3, multiple layers 22 are visible, for example, layer 22a is completed in part 14b, with extruder head 16 shown in the process of depositing layer 22b on part 14b. Of course, parts 14a, 14b illustrated in FIG. 3 are just a single example of one or more parts 14 that may be manufactured via presently disclosed systems 10, and is not meant to be limiting.

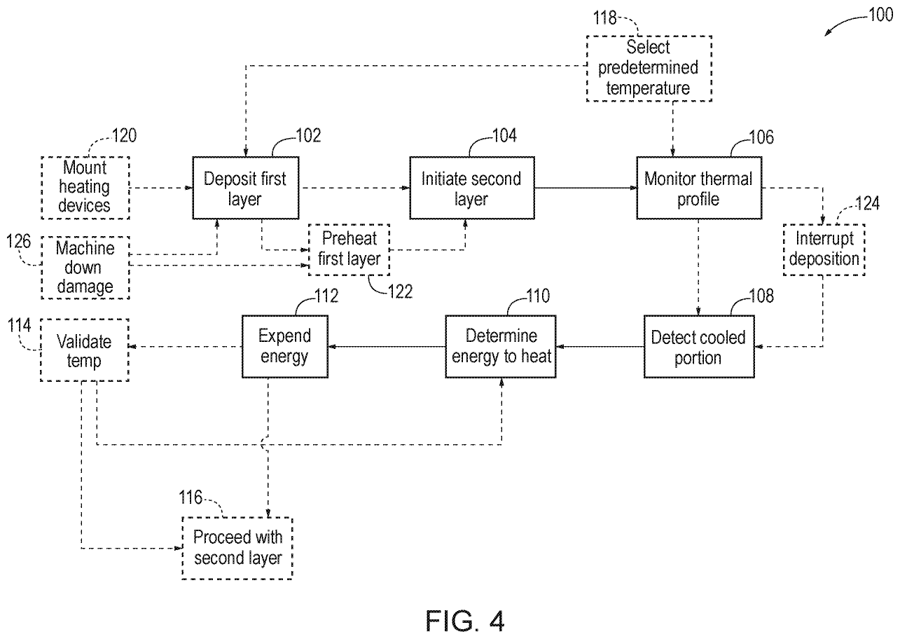

FIG. 4 schematically illustrates a flowchart that represents illustrative, non-exclusive examples of methods 100 of forming a part in a work area (e.g., part 14 in work area 12) via an additive manufacturing process, according to the present disclosure. In FIG. 4, some steps are illustrated in dashed boxes indicating that such steps may be optional or may correspond to an optional version of a method 100 according to the present disclosure. That said, not all methods 100 according to the present disclosure are required to include the steps illustrated in solid boxes. The methods 100 and steps illustrated in FIG. 4 are not limiting, and other methods and steps are within the scope of the present disclosure, including methods 100 having greater than or fewer than the number of steps illustrated, as understood from the discussions herein.

Methods 100 generally include depositing a first layer of thermoplastic material along a first path via an extruder head (e.g., extruder head 16) at 102, initiating deposition of a second layer of thermoplastic material via the extruder head at 104, and monitoring a thermal profile of the first layer of thermoplastic material along the first path while the second layer of thermoplastic material is deposited, at 106. As described above in connection with FIG. 1, the second layer of thermoplastic material is generally deposited along a second path that is added to at least a portion of the first layer of thermoplastic material. Monitoring the thermal profile at 106 is generally performed by a thermal imaging system (e.g., thermal imaging system 18) that monitors the temperature of at least a portion of the previously deposited layer of thermoplastic material just before the subsequent layer of thermoplastic material is deposited thereon. Generally, the thermal imaging system travels above and/or along the path of the previously deposited layer to monitor the thermal profile of said layer, as the subsequent layer of thermoplastic material is deposited.

If the temperature of a portion of the previously deposited layer has cooled too much so as to interfere with optimal layer-to-layer bonding, methods 100 include detecting a cooled portion of the first layer of deposited material that has a present temperature lower than a predetermined threshold temperature, at 108. Methods 100 also include determining an energy that is sufficient to raise the present temperature of the cooled portion to a higher temperature within a desired range of temperatures that is greater than or equal to the predetermined threshold temperature, at 110. Said energy is then expended (e.g., by heating system 20) at 112 to heat the cooled portion of the previously deposited layer of thermoplastic material, before the subsequent layer of thermoplastic material is added to the cooled portion. In this manner, the temperature of the previously deposited layer of thermoplastic material is heated to a sufficient temperature to ensure optimal layer-to-layer bonding before continuing deposition of the second layer of thermoplastic material along the second path at 116, without expending undue or unnecessary energy. Some methods 100 include validating (e.g., verifying) that the temperature of the cooled portion has been raised sufficiently, at 114, before continuing deposition of the second layer of thermoplastic material along the second path at 116. For example, validating the temperature at 114 may include ensuring that the cooled portion is raised to a higher temperature that is within a temperature range that is greater than or equal to the predetermined threshold temperature. Said validating at 114 may be performed prior to continuing deposition of the subsequent layer of thermoplastic material at 116. If validating the temperature at 114 results in a finding that the current temperature of the cooled portion is still below the predetermined threshold temperature, then the needed energy for heating the cooled portion may be again determined at 110, and the energy may again be expended at 112 in order to further heat the cooled portion of the previously deposited layer.

Determining an energy sufficient to raise the temperature of the cooled portion at 110 may include calculating the energy to minimize energy usage by the heating system while ensuring that the cooled portion is raised within the higher temperature range. For example, the heating system may include a processor configured to execute an algorithm to determine the energy to be expended, which may be based at least partially on the present temperature of the cooled portion, the material of the previously deposited layer, and/or the type of heating device(s) to be used by the heating system. Additionally or alternatively, the heating system may be configured to determine a sufficient energy at 110 using a lookup table or similar. In some methods 100, a controller (e.g., controller 32) may perform the function of determining a sufficient energy at 110, and then communicate to the heating system. In some methods 100, the heating system and/or the thermal imaging system may include an on-board controller and/or processor to determine a sufficient energy at 110.

Generally, the heating system travels above and/or along the path of the previously deposited layer of material as the subsequent layer of material is added thereto. Thus, initiating deposition of the subsequent layer of material at 104 and continuing to deposit the subsequent layer of material at 116 generally include moving the heating system and the thermal imaging system above the path of the previously deposited layer as the subsequent layer of material is deposited. In some methods, moving the thermal imaging system and the heating system above the path of the previous layer is accomplished by virtue of coupling the thermal imaging system and/or the heating system to the extruder head such that the thermal imaging system and heating system directly follow the same path the extruder head follows as it deposits thermoplastic material. Additionally or alternatively, the thermal imaging system and/or the heating system may be moved above the path of the previously deposited layer in another manner, such as by being movably coupled to a frame structure (e.g., a gantry or other frame structure 42) that supports the thermal imaging system and/or the heating system above the work area.

Expending energy at 112 generally includes locally heating just a portion of the part being additively manufactured. For example, expending energy at 112 involves locally heating just a small area of the previously deposited layer of thermoplastic material in some methods 100, rather than heating the entire layer and/or the entire part or work area. For example, expending energy at 112 may include heating an area of the previously deposited layer that is less than about 1 square inch in area, less than about 2 square inches in area, less than about 3 square inches in area, less than about 4 square inches in area, and/or less than about 5 square inches in area. Additionally or alternatively, expending energy at 112 may include heating an area of the previously deposited layer that is less than 5% of an overall area of the work area, less than 1% of the overall area of the work area, less than 0.5% of the overall area of the work area, less than 0.1% of the overall area of the work area, and/or less than 0.05% of the overall area of the work area.

Furthermore, expending energy at 112 generally includes locally heating a small area of the previously deposited layer that is slightly ahead of the extruder head along the direction of travel of the path of the layer of material being deposited. In this manner, the heating system is configured to heat a portion of the previously deposited layer just before the subsequently deposited layer is deposited thereon. For example, the heating system may be configured to heat an area or portion that is positioned less than 1 inch in front of the extruder head along the path of the subsequent layer, less than 2 inches in front of the extruder head along the path of the subsequent layer, less than 4 inches in front of the extruder head along the path of the subsequent layer, less than 6 inches in front of the extruder head along the path of the subsequent layer, less than 8 inches in front of the extruder head along the path of the subsequent layer, and/or less than 10 inches in front of the extruder head along the path of the subsequent layer.

In some methods 100, energy may be expended at 112 to raise the temperature of the cooled portion to a higher temperature that comprises a range of temperatures, with said range of temperatures spanning less than 10 Fahrenheit (° F.) apart, less than 9° F. apart, less than 8° F. apart, less than 7° F. apart, less than 6° F. apart, less than 5° F. apart, less than 4° F. apart, less than 3° F. apart, less than 2° F. apart, and/or less than 1° F. apart.

In some methods 100, the thermal profile of the previously deposited layer is monitored continuously at 106 during the time the part is being manufactured (e.g., during the times that the extruder head is depositing material). Additionally or alternatively, the thermal profile of the previously deposited layer may be monitored at 106 periodically and/or selectively, during and/or between times of depositing layers of material to form the part.

Detecting a cooled portion of the first layer of deposited material at 108 may include comparing the thermal profile to the predetermined threshold temperature. In other words, detecting a cooled portion of the first layer of deposited material at 108 may be based on comparing the thermal profile to the predetermined threshold temperature and determining that the present temperature of the previously deposited layer is lower than the predetermined threshold temperature.

Methods 100 may include selecting the predetermined threshold temperature at 118, which may be based at least partially on the materials being deposited and the travel speed of the extruder head. For example, selecting the predetermined threshold temperature at 118 may include lowering the predetermined threshold temperature when the travel speed of the extruder head increases, and increasing the predetermined threshold temperature when the travel speed of the extruder head decreases.

Some methods 100 include mounting a plurality of heating devices at 120 with respect to the work area (e.g., above the work area), such that each heating device of the plurality of heating devices is configured to heat a different respective area of the part during depositing the first layer of thermoplastic material at 102 and during depositing the second layer of thermoplastic material at 104 and 116. Additionally or alternatively, some methods 100 include preheating each respective area of the part individually at 122, via a respective heating device of the plurality of heating devices, wherein the preheating of each respective area at 122 is performed before the extruder head deposits the second layer of thermoplastic material on the respective area.

Some methods 100 include interrupting deposition at 124. Said interruption may be for a period of time that is long enough that the previously deposited layer or partial layer is no longer heated to a sufficient temperature to allow for optimal layer-to-layer bonding with subsequent layers. Said interruption may be intentional or accidental. Interrupting the deposition at 124 may include causing (selectively or otherwise) an interruption of the extruder head for a time sufficient to cool the first layer of thermoplastic material below the predetermined threshold temperature. Additionally or alternatively, interrupting the deposition at 124 may include powering down the extruder head for a time sufficient to cool the first layer of thermoplastic material below the predetermined threshold temperature, and restarting the extruder head prior to the continuing to deposit the second layer of thermoplastic material. Energy may then be expended at 112 to reheat a given area of thermoplastic material before resuming deposition of the next layer on that given area. In specific examples, the extruder head may be powered down, or the deposition otherwise interrupted, for a period of time that is greater than 5 minutes, greater than 7 minutes, and/or greater than 10 minutes. While in conventional methods, such an interruption may have resulted in scrapping the partially completed part, presently disclosed methods and systems may be configured to allow for continuation of the partial part while still creating a finished part with sufficient strength between bonded layers, and thereby reducing potential waste (and thereby providing potential cost savings in both material cost and operator time) as compared to conventional techniques. Thus, presently disclosed systems and methods may provide more flexibility in allowing a deposition to be started and stopped repeatedly without compromising the resulting part. Additionally or alternatively, disclosed methods 100 and systems 10 may allow for the production of larger parts because the size of printed parts is often limited by the time needed to print larger parts being too great to allow for optimal layer-to-layer bonding.

Methods 100 may be used to repair a damaged area of and/or modify a part comprising a thermoplastic material. For instance, within examples, the first layer is a repair area or modification area that includes stable material, and expending the energy heat the stable material to within the higher temperature range before a subsequent (e.g., second) layer of thermoplastic material is added to the stable material. In such an example of method 100, a damaged area is machined down at 126 until stable material is reached, thereby removing the damaged area and forming a repair area. In another example of method 100, the area to be modified is machined down at 126 until a sufficient amount of material is removed to perform the desired modification, thereby forming a modification area that includes stable material. In such methods, determining the energy at 110 includes determining an energy that is sufficient to raise a present temperature of the stable material in the repair area or modification area within a higher temperature range that is greater than or equal to a predetermined threshold temperature. Likewise, expending the energy at 112 may include heating the stable material in the repair area or modification area to within the higher temperature range before a second or subsequent layer of thermoplastic material is added to the stable material via the extruder head, where the subsequent layer of thermoplastic material is added to the stable material along a path within the repair area or modification area. Within examples, monitoring the thermal profile at 106 includes monitoring the thermal profile of the stable material along the path while the subsequent layer of thermoplastic material is deposited along said path, where the monitoring is performed by thermal imaging system 18 that travels above the path as the subsequent layer is deposited.

Illustrative, non-exclusive examples of inventive subject matter according to the present disclosure are described in the following enumerated paragraphs:

A1. A method of forming a part in a work area via an additive manufacturing process, the method comprising:

depositing a first layer of thermoplastic material via an extruder head, wherein the first layer of thermoplastic material is deposited along a first path;

initiating deposition of a second layer of thermoplastic material via the extruder head, wherein the second layer of thermoplastic material is deposited along a second path that is added to at least a portion of the first layer of thermoplastic material;

monitoring a thermal profile of the first layer of thermoplastic material along the first path while the second layer of thermoplastic material is deposited;

detecting a cooled portion of the first layer of thermoplastic material having a present temperature that is lower than a predetermined threshold temperature;

determining an energy that is sufficient to raise the present temperature of the cooled portion within a higher temperature range that is greater than or equal to the predetermined threshold temperature;

expending the energy, thereby heating the cooled portion of the first layer of thermoplastic material to within the higher temperature range before the second layer of thermoplastic material is added to the cooled portion; and continuing deposition of the second layer of thermoplastic material along the second path after heating the cooled portion to within the higher temperature range.

A1.1. The method of paragraph A1, wherein the monitoring comprises continuously monitoring during the initiating and the continuing to deposit.

A1.2. The method of any of paragraphs A1-A1.1, wherein the monitoring is performed by a thermal imaging system.

A1.3. The method of paragraph A1.2, wherein the thermal imaging system travels above and/or along the first path as the second layer of thermoplastic material is deposited.

A1.4. The method of any of paragraphs A1-A1.3, further comprising comparing the thermal profile to the predetermined threshold temperature.

A1.5. The method of paragraph A1.4, wherein the detecting the cooled portion is based on the comparing the thermal profile to the predetermined threshold temperature.

A1.6. The method of any of paragraphs A1-A1.5, wherein the expending the energy is performed by a heating system.

A1.7. The method of paragraph A1.6, wherein the heating system travels above the first path as the second layer of thermoplastic material is deposited.

A.1.8. The method of any of paragraphs A1-A1.7, further comprising moving a/the thermal imaging system above the first path as the second layer of thermoplastic material is deposited.

A1.9. The method of any of paragraphs A1-A1.8, further comprising moving a/the heating system above the first path as the second layer of thermoplastic material is deposited.

A2. The method of any of paragraphs A1-A1.9, wherein a/the thermal imaging system comprises one or more thermal sensors.

A3. The method of any of paragraphs A1-A2, wherein a/the thermal imaging system comprises a thermal imaging camera.

A4. The method of any of paragraphs A1-A3, wherein a/the thermal imaging system is coupled to the extruder head such that the thermal imaging system directly follows a path traveled by the extruder head.

A5. The method of any of paragraphs A1-A4, wherein a/the thermal imaging system is coupled to a frame positioned above the first layer of thermoplastic material.

A6. The method of any of paragraphs A1-A5, wherein a/the heating system is coupled to the extruder head such that the heating system directly follows the path traveled by the extruder head.

A7. The method of any of paragraphs A1-A6, wherein a/the heating system is coupled to a/the frame positioned above the first layer of thermoplastic material.

A8. The method of any of paragraphs A1-A7, wherein a/the heating system comprises an infrared heater.

A9. The method of any of paragraphs A1-A8, wherein a/the heating system comprises a laser heating system.

A9.1. The method of any of paragraphs A1-A9, wherein a/the heating system comprises a directed energy heating system.

A10. The method of any of paragraphs A1-A9.1, wherein a/the heating system comprises a non-contact heating system.

A11. The method of any of paragraphs A1-A10, further comprising verifying that the cooled portion is sufficiently heated within the higher temperature range and is greater than or equal to the predetermined threshold temperature, wherein the verifying is performed prior to the continuing deposition of the second layer of thermoplastic material.

A12. The method of any of paragraphs A1-A11, wherein a/the heating system is configured to locally heat small areas of the first layer of thermoplastic material one at a time.

A12.1. The method of any of paragraphs A1-A12, wherein the expending the energy comprises locally heating small areas of the first layer of thermoplastic material one at a time, via a/the heating system.

A13. The method of paragraph A12 or A12.1, wherein each small area is less than about 0.5 square inches in area, less than about 1 square inch in area, less than about 2 square inches in area, less than about 3 square inches in area, less than about 4 square inches in area, and/or less than about 5 square inches in area.

A14. The method of any of paragraphs A12-A13, wherein each small area is less than 5% of an overall area of the work area, less than 1% of the overall area of the work area, less than 0.5% of the overall area of the work area, less than 0.1% of the overall area of the work area, and/or less than 0.05% of the overall area of the work area.

A15. The method of any of paragraphs A12-A14, wherein each small area the heating system is configured to heat is positioned less than 1 inch in front of the extruder head along the second path, less than 2 inches in front of the extruder head along the second path, less than 4 inches in front of the extruder head along the second path, less than 6 inches in front of the extruder head along the second path, less than 8 inches in front of the extruder head along the second path, and/or less than 10 inches in front of the extruder head along the second path.

A16. The method of any of paragraphs A1-A15, wherein the determining the energy comprises calculating the energy to minimize energy usage by a/the heating system while ensuring that the cooled portion is raised to within the higher temperature range.

A16. The method of any of paragraphs A1-A15, wherein the higher temperature range comprises a range of temperatures spanning less than 10 Fahrenheit (° F.) apart, less than 9° F. apart, less than 8° F. apart, less than 7° F. apart, less than 6° F. apart, less than 5° F. apart, less than 4° F. apart, less than 3° F. apart, less than 2° F. apart, and/or less than 1° F. apart.

A17. The method of any of paragraphs A1-A16, wherein the extruder head comprises a rotating extruder head.

A17.1. The method of any of paragraphs A1-A17, wherein the thermal imaging system and/or the heating system are configured to rotate with respect to the extruder head.

A18. The method of any of paragraphs A1-A17.1, wherein the extruder head comprises a fixed extruder head of a fused filament system.

A18.1. The method of any of paragraphs A1-A18, wherein the extruder head comprises a polymer pellet extruder head.

A19. The method of any of paragraphs A1-A18.1, wherein the additive manufacturing process comprises 3D printing, wherein the first layer of thermoplastic material comprises a first 3D printed layer, and wherein the second layer of thermoplastic material comprises a second 3D printed layer.

A20. The method of any of paragraphs A1-A19, wherein an/the overall area of the work area is at least 5 square feet, at least 10 square feet, at least 15 square feet, at least 20 square feet, at least 25 square feet, at least 30 square feet, at least 35 square feet, at least 40 square feet, at least 45 square feet, at least 50 square feet, at least 75 square feet, and/or at least 100 square feet.

A21. The method of any of paragraphs A1-A20, further comprising selecting the predetermined threshold temperature based at least partially on a travel speed of the extruder head.

A22. The method of any of paragraphs A1-A21, further comprising lowering the predetermined threshold temperature when a/the travel speed of the extruder head increases and increasing the predetermined threshold temperature when the travel speed of the extruder head decreases.

A23. The method of any of paragraphs A1-A22, further comprising mounting a plurality of heating devices above the work area such that each heating device of the plurality of heating devices is configured to heat a different respective area of the part during the depositing the first layer of thermoplastic material and during the depositing the second layer of thermoplastic material.

A23.1. The method of any of paragraphs A1-A23, further comprising preheating each respective area of the part individually via a respective heating device of a/the plurality of heating devices, wherein the preheating of each respective area is performed before the extruder head deposits the second layer of thermoplastic material on the respective area.

A23.2. The method of any of paragraphs A1-A23.1, wherein a/the heating system comprises a/the plurality of heating devices positioned above the work area such that each respective heating device of the plurality of heating devices is configured to heat a different respective area of the part during the depositing the first layer of thermoplastic material and during deposition of the second layer of thermoplastic material.

A24. The method of any of paragraphs A1-A23.2, further comprising:

powering down the extruder head for a time sufficient to cool the first layer of thermoplastic material below the predetermined threshold temperature; and

restarting the extruder head prior to the continuing to deposit the second layer of thermoplastic material, wherein the expending the energy is performed after the powering down the extruder head.

A24.1. The method of any of paragraphs A1-A24, further comprising causing an interruption of the extruder head for a time sufficient to cool the first layer of thermoplastic material below the predetermined threshold temperature, wherein the expending the energy is performed after the causing the interruption.

A25. The method of paragraph A24 or A24.1, wherein the time is greater than 5 minutes, greater than 7 minutes, and/or greater than 10 minutes.

A26. The method of any of paragraphs A1-A25, wherein the first layer is a repair area comprising stable material, and wherein the expending the energy comprises heating the stable material to within the higher temperature range before the second layer of thermoplastic material is added to the stable material.

B1. A method for repairing a damaged area of a part comprising a thermoplastic material, the method comprising:

machining down the damaged area until stable material is reached, thereby removing the damaged area and forming a repair area;

determining an energy that is sufficient to raise a present temperature of the stable material to within a higher temperature range that is greater than or equal to a predetermined threshold temperature;

expending the energy, thereby heating the stable material to within the higher temperature range before a subsequent layer of thermoplastic material is added to the stable material via an extruder head, wherein the subsequent layer of thermoplastic material is added to the stable material along a path within the repair area, and wherein the expending the energy is performed by a heating system that travels above the path as the subsequent layer of thermoplastic material is deposited; and monitoring a thermal profile of the stable material along the path while the subsequent layer of thermoplastic material is deposited, wherein the monitoring is performed by a thermal imaging system that travels above the path as the subsequent layer of thermoplastic material is deposited.

B2. The method of paragraph B1, wherein the monitoring comprises continuously monitoring during deposition of the subsequent layer of thermoplastic material.

B3. The method of any of paragraphs B1-B2, further comprising comparing the thermal profile to the predetermined threshold temperature.

C1. A large area additive manufacturing system, comprising:

an extruder head configured to deposit a plurality of layers of thermoplastic material;

a thermal imaging system configured to monitor a thermal profile of a first layer of thermoplastic material while a second layer of thermoplastic material is deposited on the first layer of thermoplastic material via the extruder head, wherein the thermal imaging system travels above a first path of the first layer of thermoplastic material while the second layer of thermoplastic material is deposited, wherein the thermal imaging system is further configured to compare the thermal profile to a predetermined threshold temperature and to detect a cooled portion of the first layer of thermoplastic material having a present temperature that is lower than the predetermined threshold temperature, based on the thermal profile; and

a heating system configured to travel above the first path as the second layer of thermoplastic material is deposited, wherein the heating system is configured to heat the cooled portion to within a higher temperature range that is greater than or equal to the predetermined threshold temperature before the second layer of thermoplastic material is added to the cooled portion, wherein the thermal imaging system is configured to determine and/or calculate an energy sufficient to raise the present temperature of the cooled portion to within the higher temperature range, and wherein the heating system is configured to expend the energy determined and/or calculated by the thermal imaging system such that the energy expended by the heating system is minimized.

C2. The large area additive manufacturing system of paragraph C1, wherein the extruder head comprises a rotating extruder head.

C2.1. The large area additive manufacturing system of paragraph C1 or C2, wherein the thermal imaging system and/or the heating system are configured to rotate with respect to the extruder head.

C3. The large area additive manufacturing system of any of paragraphs C1-C2.1, wherein the extruder head comprises a fixed extruder head for fused filament fabrication.

C3.1. The large area additive manufacturing system of any of paragraphs C1-C3, wherein the extruder head comprises a polymer pellet extruder head.

C4. The large area additive manufacturing system of any of paragraphs C1-C3.1, wherein the thermal imaging system is coupled to the extruder head.

C5. The large area additive manufacturing system of any of paragraphs C1-C4, wherein the heating system is coupled to the extruder head.

C6. The large area additive manufacturing system of any of paragraphs C1-05, wherein the heating system is arranged such that it is configured to heat an area of the first path that is ahead of the extruder head along the first path.

C7. The large area additive manufacturing system of any of paragraphs C1-C6, further comprising a frame positioned above the first path, wherein the thermal imaging system comprises a plurality of thermal sensors coupled to the frame, wherein the heating system comprises a plurality of heating devices coupled to the frame, and wherein each respective heating device of the plurality of heating devices is configured to deliver heat from the heating device to a respective discrete section of the first layer of thermoplastic material.

C8. The large area additive manufacturing system of any of paragraphs C1-C7, wherein the thermal imaging system comprises a thermal imaging camera.

C9. The large area additive manufacturing system of any of paragraphs C1-C8, wherein the heating system comprises an infrared heater.

C10. The large area additive manufacturing system of any of paragraphs C1-C9, wherein the heating system comprises a laser heating system.

C10.1. The large area additive manufacturing system of any of paragraphs C1-C10, wherein the heating system comprises a directed energy heating system.

C11. The large area additive manufacturing system of any of paragraphs C1-C10.1, wherein the heating system comprises a non-contact heating system.

C12. The large area additive manufacturing system of any of paragraphs C1-C11, wherein the heating system is configured to locally heat a small area of the first layer of thermoplastic material at a time.

C13. The large area additive manufacturing system of paragraph C12, wherein the small area is less than about 0.5 square inches in area, less than about 1 square inch in area, less than about 2 square inches in area, less than about 3 square inches in area, less than about 4 square inches in area, and/or less than about 5 square inches in area.

C14. The large area additive manufacturing system of paragraph C12 or C13, wherein the small area is less than 5% of an overall area of the work area, less than 1% of the overall area of the work area, less than 0.5% of the overall area of the work area, less than 0.1% of the overall area of the work area, and/or less than 0.05% of the overall area of the work area.

C15. The large area additive manufacturing system of any of paragraphs C12-C14, wherein the small area the heating system is configured to heat is positioned less than 1 inch in front of the extruder head along a second path, less than 2 inches in front of the extruder head along the second path, less than 4 inches in front of the extruder head along the second path, less than 6 inches in front of the extruder head along the second path, less than 8 inches in front of the extruder head along the second path, and/or less than 10 inches in front of the extruder head along the second path.

D1. The use of the large area additive manufacturing system of any of paragraphs C1-C15 to manufacture a part.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, or A, B, and C together, and optionally any of the above in combination with at least one other entity.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

1. A method of performing an additive manufacturing process in a work area, the method comprising:
depositing a first layer of thermoplastic material via an extruder head, wherein the first layer of thermoplastic material is deposited along a first path;
initiating deposition of a second layer of thermoplastic material via the extruder head, wherein the second layer of thermoplastic material is deposited along a second path that is added to at least a portion of the first layer of thermoplastic material;
monitoring a thermal profile of the first layer of thermoplastic material along the first path while the second layer of thermoplastic material is deposited;
detecting a cooled portion of the first layer of thermoplastic material having a present temperature that is lower than a predetermined threshold temperature;
determining an energy that is sufficient to raise the present temperature of the cooled portion to within a higher temperature range that is greater than or equal to the predetermined threshold temperature;
expending the energy, thereby heating the cooled portion of the first layer of thermoplastic material to within the higher temperature range before the second layer of thermoplastic material is added to the cooled portion; and
continuing deposition of the second layer of thermoplastic material along the second path after heating the cooled portion to within the higher temperature range.

2. The method according to claim 1, wherein the monitoring is performed by a thermal imaging system that comprises a thermal imaging camera coupled to the extruder head, and wherein the method further comprises:
moving the thermal imaging system above the first path as the second layer of thermoplastic material is deposited.

3. The method according to claim 1, wherein the expending the energy is performed by a heating system that comprises a directed energy heating system coupled to the extruder head, and wherein the method further comprises:
moving the heating system above the first path as the second layer of thermoplastic material is deposited.

4. The method according to claim 1, further comprising verifying that the cooled portion is sufficiently heated such that the higher temperature range is greater than or equal to the predetermined threshold temperature, wherein the verifying is performed prior to the continuing deposition of the second layer of thermoplastic material along the second path.

5. The method according to claim 1, wherein the expending the energy comprises locally heating small areas of the first layer of thermoplastic material one at a time, via a heating system, wherein each small area is less than 1% of an overall area of the work area.

6. The method according to claim 1, wherein the expending the energy is performed by a heating system, and wherein the determining the energy comprises calculating the energy to minimize energy usage by the heating system while ensuring that the cooled portion is raised to within the higher temperature range.

7. The method according to claim 1, wherein the monitoring is performed by a thermal imaging system, wherein the expending the energy is performed by a heating system, and wherein the thermal imaging system and the heating system are configured to rotate with respect to the extruder head.

8. The method according to claim 1, wherein the extruder head comprises a polymer pellet extruder head.

9. The method according to claim 1, further comprising selecting the predetermined threshold temperature based at least partially on a travel speed of the extruder head.

10. The method according to claim 1, wherein the expending the energy is performed by a heating system that comprises a plurality of heating devices positioned above the work area such that each heating device of the plurality of heating devices is configured to heat a different respective area of a part being formed by the additive manufacturing process during the depositing the first layer of thermoplastic material and during the continuing deposition of the second layer of thermoplastic material, and wherein the method further comprises preheating each respective area of the part individually via a respective heating device of the plurality of heating devices, wherein the preheating of each respective area is performed before the extruder head deposits the second layer of thermoplastic material on the respective area.

11. The method according to claim 1, further comprising causing an interruption of the extruder head for a time sufficient to cool the first layer of thermoplastic material below the predetermined threshold temperature, wherein the expending the energy is performed after the causing the interruption.

12. The method according to claim 1, wherein the first layer is a repair area comprising stable material, and wherein the expending the energy comprises heating the stable material to within the higher temperature range before the second layer of thermoplastic material is added to the stable material.

13. A method for repairing a damaged area of a part comprising a thermoplastic material, the method comprising:
machining down the damaged area until stable material is reached, thereby removing the damaged area and forming a repair area;
determining an energy that is sufficient to raise a present temperature of the stable material to within a higher temperature range that is greater than or equal to a predetermined threshold temperature;
expending the energy, thereby heating the stable material to within the higher temperature range before a subsequent layer of thermoplastic material is added to the stable material via an extruder head, wherein the subsequent layer of thermoplastic material is added to the stable material along a path within the repair area, and wherein the expending the energy is performed by a heating system that travels above the path as the subsequent layer of thermoplastic material is deposited; and
monitoring a thermal profile of the stable material along the path while the subsequent layer of thermoplastic material is deposited, wherein the monitoring is performed by a thermal imaging system that travels above the path as the subsequent layer of thermoplastic material is deposited.

14. A large area additive manufacturing system, comprising:
an extruder head configured to deposit a plurality of layers of thermoplastic material;
a thermal imaging system configured to monitor a thermal profile of a first layer of thermoplastic material while a second layer of thermoplastic material is deposited on the first layer of thermoplastic material via the extruder head, wherein the thermal imaging system travels above a first path of the first layer of thermoplastic material while the second layer of thermoplastic material is deposited, wherein the thermal imaging system is further configured to compare the thermal profile to a predetermined threshold temperature and to detect a cooled portion of the first layer of thermoplastic material having a present temperature that is lower than the predetermined threshold temperature, based on the thermal profile; and
a heating system configured to travel above the first path as the second layer of thermoplastic material is deposited, wherein the heating system is configured to heat the cooled portion to within a higher temperature range that is greater than or equal to the predetermined threshold temperature before the second layer of thermoplastic material is added to the cooled portion, wherein the thermal imaging system is configured to determine an energy sufficient to raise the present temperature of the cooled portion to within the higher temperature range, and wherein the heating system is configured to expend the energy determined by the thermal imaging system such that the energy expended by the heating system is minimized.

15. The large area additive manufacturing system according to claim 14, wherein the thermal imaging system and the heating system are configured to rotate with respect to the extruder head.

16. The large area additive manufacturing system according to claim 15, wherein the thermal imaging system is coupled to the extruder head such that the thermal imaging system directly follows a path traveled by the extruder head.

17. The large area additive manufacturing system according to claim 16, wherein the heating system is coupled to the extruder head such that the heating system directly follows the path traveled by the extruder head.

18. The large area additive manufacturing system according to claim 14, wherein the heating system is arranged such that it is configured to heat an area of the first path that is ahead of the extruder head along the first path.

19. The large area additive manufacturing system according to claim 14, further comprising a frame positioned above the first path, wherein the thermal imaging system comprises a plurality of thermal sensors coupled to the frame, wherein the heating system comprises a plurality of heating devices coupled to the frame, and wherein each respective heating device of the plurality of heating devices is configured to deliver heat from the heating device to a respective discrete section of the first layer of thermoplastic material.

20. The large area additive manufacturing system according to claim 14, wherein the heating system is configured to locally heat small areas of the first layer of thermoplastic material one at a time, wherein each small area is less than 1% of an overall area of the work area.
